(19) United States
(12) Patent Application Publication
(10) Pub. No.: US 2011/0287806 A1
(43) Pub. Date: Nov. 24, 2011

(54) MOTION-BASED TUNE COMPOSITION ON A MOBILE DEVICE

(76) Inventors: PREETHA PRASANNA VASUDEVAN, Kollam (IN); Saravappa Kore, Kumool (IN)

(21) Appl. No.: 12/782,535

(22) Filed: May 18, 2010

(51) Int. Cl. H04M 1/21

(52) U.S. Cl. 455/556.1

(57) ABSTRACT

A wireless handset that senses motion and converts the sensed motion into an audio signal is described. The wireless handset includes a processor, an accelerometer operatively coupled to the processor, and a speaker operatively coupled to the processor. As the device is moved, the accelerometer produces a signal representing the movement of the device. The processor converts the accelerometer signal into an audio signal. The audio signal is emitted by the speaker. Thus, as a user moves the wireless handset through space, the user can hear the audio signal, and becomes aware of the correlation between the motion of the wireless handset and the sounds emitted from the speaker.

### FIELD

The present invention relates to a device and method for generating an audio signal with characteristics that vary based on the movement of the device. More particularly, the invention relates to a wireless handset with motion sensing capability, conversion of the motion signal generated in response to movement of the wireless handset into an audio signal, and playback of the audio signal.

### BACKGROUND

Applications for composing tunes on a wireless handset provide entertainment and allow the handset user to create unique ringtones. However, the user must know how to use a keypad or similar interface to enter information representing the frequency and duration of each note in the tune.

At present, wireless handsets lack a simple method for music composition. A person lacking musical training may have difficulty determining the frequency and duration characteristics of the notes needed to compose a tune. Moreover, the process of using a keypad to enter notes one at a time is tedious and time consuming. Finally, the user must first compose a sequence of notes and then play back the sequence to hear the composed tune. Thus, the user does not receive instantaneous feedback on the sound of the notes in sequence as the notes are added to the tune.

### SUMMARY

A wireless handset that senses motion and converts the sensed motion into an audio signal is described. The wireless handset includes a processor, an accelerometer operatively coupled to the processor, and a speaker operatively coupled to the processor. As the device is moved, the accelerometer produces a signal representing the motion of the device. The processor converts the accelerometer signal into an audio signal. The speaker comprises a transducer that converts the audio signal into audible sound. As a user moves the wireless handset through space, the user can hear the sound emitted by the speaker, and becomes aware of the correlation between the motion of the wireless handset and the audio signal produced.

The wireless handset may also include a memory module. The presence of a memory module allows the composed tune to be stored in memory. The stored tune may be used in association with various functions of the wireless handset. For example, the stored tune may be used as a ringtone for the wireless handset.

A display operatively coupled to the processor may be included in the wireless handset. The display may show a visual representation of the tones as they are produced, to give real time feedback to the user regarding the correlation between the motion of the wireless handset and the tones. The display may further present a visual representation of a composed tune. The display may show a visual representation of a composed tune stored in memory. Alternatively, the display may show a visual representation of a composed tune not stored in memory.

In another embodiment, a wireless handset includes a processor and a motion sensing means operatively coupled to the processor. A user moves the wireless handset through space. The motion sensing means produces a motion signal representing the movement of the device as the user moves the device. The processor converts the motion signal from the motion sensing means into an audio signal.

A method for producing an audio signal with a wireless handset is also described. The method involves a user moving a wireless handset through space. The motion of the handset is sensed by an accelerometer. The accelerometer generates an accelerometer signal representing the motion of the handset. The wireless handset has a processor that converts the accelerometer signal into an audio signal. The audio signal is reproduced by a speaker, which renders the signal audible to the user. The user receives feedback on the correlation between the motion of the wireless handset and the resulting tones produced by the wireless handset speaker.

### DRAWINGS

The illustrative embodiment will be more fully understood by reference to the following drawings which are for illustrative, not limiting, purposes.

FIG. 1 shows an illustrative wireless handset.

FIG. 2 shows an illustrative communication system, in which the wireless handset features an accelerometer operatively connected with a processor.

FIG. 3 shows an illustrative wireless handset being moved by a user.

FIG. 4 shows an illustrative flowchart of the method for generating an audio signal in response to wireless handset motion.

FIG. 5 shows an illustrative flowchart of the method for generating an audio signal responsive to wireless handset motion.

FIG. 6 shows an illustrative flowchart of a method for recording the audio signal generated in response to wireless handset motion.

### DETAILED DESCRIPTION

Persons of ordinary skill in the art will realize that the following description is illustrative and not in any way limiting. Other embodiments of the claimed subject matter will readily suggest themselves to such skilled persons having the benefit of this disclosure. It shall be appreciated by those of ordinary skill in the art that the wireless handset, systems, and methods described hereinafter may vary as to configuration and as to details.

A wireless handset and method for enabling the device to produce an audio signal with varying characteristics based on the movement of the device is described herein. The wireless handset includes a processor, an accelerometer operatively coupled to the processor, and a speaker operatively coupled to the processor.

The user of the wireless handset may begin composition of a tune by initiating a Tune Composer application. The wireless handset may be silent in an initial position occupied by the handset when the application is initiated. When the wireless handset is moved away from the initial position, a speaker emits a tone that is an audible sound signal having a particular frequency. The frequency of the tone varies relative to the distance of a new wireless handset position from its initial position.

Alternatively, the wireless handset may emit an initial tone in an initial position. With each change in position, the frequency of the audio signal varies in relation to the distance between the new position and the initial position. When the wireless handset is held still, the tone is sustained until the wireless handset is moved again or until the tune composition is terminated.

A tone may be a sampled or digitally created sound signal. For example, a tone may be a sine wave having a particular frequency, such as 261 Hz. Alternatively, the tone may have a waveform other than a sine wave, for example, a sampled instrument having a fundamental frequency such as 261 Hz. The tone may be a waveform comprising a fundamental frequency and various higher harmonics to simulate the waveform of various instruments. Below, descriptions of a tone having a particular frequency may indicate that the tone is a wave having a particular frequency or that the tone is a wave having a particular fundamental frequency.

The sound output device may be any means of rendering an audio signal audible to the user of the wireless handset. For example, the sound output device may comprise a headphone jack that allows a user to hear the audio signal through headphones connected to the headphone jack. The sound output device may be capable of reproducing a mono signal. Alternatively, the sound output device may be capable of reproducing a stereo signal.

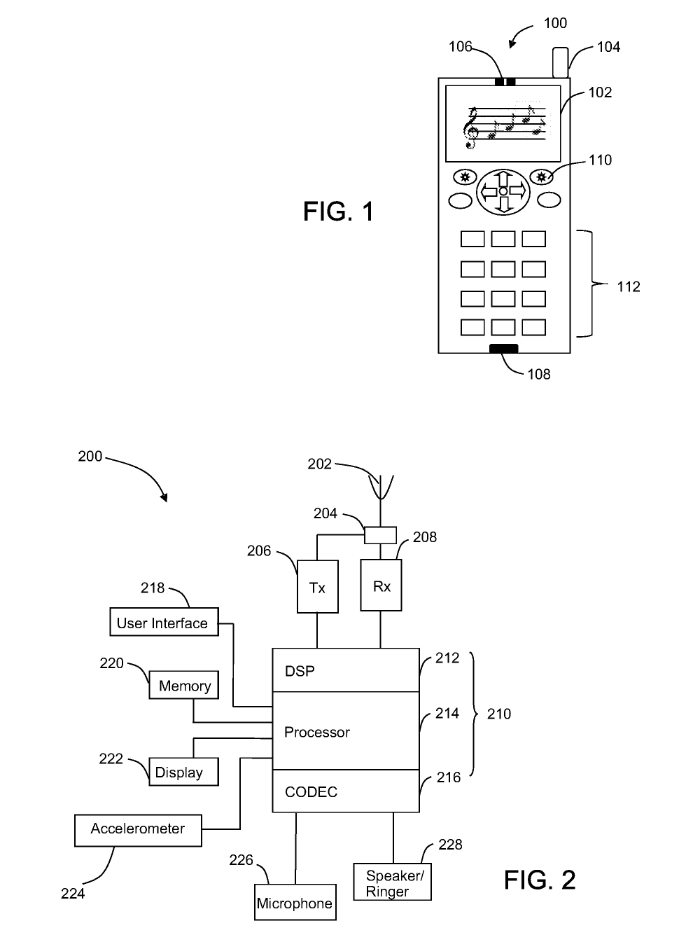

Referring to FIG. 1, there is shown a wireless handset 100. The illustrative wireless handset can also be referred to as a wireless communication device, a mobile handset, mobile phone, wireless phone, portable cell phone, cellular phone, portable phone, a personal digital assistant (PDA), or any type of mobile terminal which is regularly carried by a user and has all the elements necessary for operation in a wireless communication system. The wireless handset 100 includes a display 102, an antenna 104, a speaker 106, and a microphone 108. After initiating the Tune Composer application, the user moves wireless handset 100 through space. The motion is detected by an accelerometer. The accelerometer signal is converted into an audio signal which is routed to speaker 106. In some embodiments, the display 102 shows information representing the tones generated using the Tune Composer. For example, the display 102 may show a music note or multiple music notes on a staff. The music note or notes on the staff represent the tones emitted by the speaker in response to the motion of the handset. Flashes of color or other means of representation may be shown on the display to indicate the relationship between the motion of the wireless handset and the tones produced.

If the entire tune does not fit on a single display screen or it is otherwise advantageous to show the tune over a series of screens rather than on a single display screen, a segment of the tune may be shown on the display screen. The user may then advance to a next segment of the tune by entering an indication using a user interface. For example, the user may advance the display to a next segment of the tune by hitting a soft key 110 or by hitting a designated key on the keypad 112. Other user interfaces, such as a touchscreen interface, may be used to interact with the Tune Composer application to perform functions such as advancing to a next segment of a tune.

Referring to FIG. 2, there is shown a plurality of components associated with an illustrative wireless handset. The illustrative wireless handset 202 comprises a first antenna element 201 that is operatively coupled to a duplexer 204, which is operatively coupled to a transmitter module 206, and a receiver module 208.

An illustrative control module 210 comprises a digital signal processor (DSP) 212, a processor 214, and a CODEC 216 that are communicatively coupled to the transmitter 206 and receiver 208. It shall be appreciated by those of ordinary skill in the art that the transmitter module and receiver module are typically paired and may be embodied as a transceiver. The DSP 212 may be configured to perform a variety of operations such as controlling the antenna 202, the transmitter module 206, and the receiver module 208.

The processor 214 is operatively coupled to a user interface 218, memory 220, and display 222. Additionally, the processor 214 is also operatively coupled to a CODEC module 216 that performs the encoding and decoding operations and is communicatively coupled to microphone 226 and a speaker 228. The CODEC module 216 is also communicatively coupled to the display 222 and provides the encoding and decoding operations for video.

In some embodiments, the processor is operatively coupled to an accelerometer 224. The accelerometer senses non-gravitational acceleration imparted to the device in one or more axes. The change in the position of the wireless handset may be derived from the acceleration signal produced by the accelerometer. The accelerometer comprises a sensing element that is used to determine the acceleration to which the wireless handset is exposed. The sensing element may utilize, by way of example, capacitive, piezoelectric, piezoresistive, or MEMS (Micro-Electro Mechanical System) technology. It will be recognized that other technologies may be utilized to provide data regarding changes in the position of the handset to the processor, and that the data produced in this manner may be converted to an audio signal by a processor as described above.

In one illustrative embodiment, the particular or “active” axis may correspond to the axis along which a single-axis accelerometer measures acceleration. For example, vertical movement of the wireless handset from an average waist height to an average head height may be used.

In operation, the initial position of the wireless handset is assumed within the Tune Composer application to be at a point midway between the average waist height and average head height, and assigned a respective initial frequency of 261 Hz. A small movement in the direction of the average head height (up toward the sky) results in production of a tone with a frequency that is slightly higher than 261 Hz, for example, 440 Hz. A larger movement in the direction of the head results in production of a tone with a frequency that is much higher than 261 Hz, for example, 522 Hz. Similarly, a small movement in the direction of the average waist height (down toward the ground) may result in production of a tone with a frequency that is slightly lower than 261 Hz, for example, 220 Hz. A large movement in the direction of the average waist height (down toward the ground) may result in production of a tone that is much lower than 261 Hz, for example, 130 Hz. Alternatively, the user could be prompted within the Tune Composer application to enter their actual height, which could be used in determining the available range of frequencies and position changes to be associated with the production of tones with varying frequencies. The single axis may be a vertical axis, as described above, or may be another axis.

The change in position along a single axis is used in the production of tones with various frequencies, various motion sensing devices may be used. A single axis accelerometer may be used, with the change in position occurring along the single axis of the accelerometer affecting the frequencies of the tones produced. Alternatively, a multi-axial accelerometer may be used. In this case, the Tune Composer application may utilize data from one of the multiple axes available. The single axis may be fixed, or the processor may use data from the first axis along which acceleration is sensed, or from the axis along which the greatest acceleration amplitude is sensed.

In some embodiments, a multi-axial accelerometer will provide data indicating the acceleration along multiple axes. The movement along a first axis may result in different tune composition functions from movement along a second or third axis. For example, rests could be inserted into the tune when movement is along a first axis while tones are inserted into the tune when movement is along a second axis. Tones with varying waveforms could be produced as a result of motion along different axes. For example, a tone comprising a first sampled waveform (for example, a piano waveform) could be produced as a result of a first movement along a first axis, and a tone comprising a second sampled waveform (for example, a violin waveform) could be produced as a result of a second movement along a second axis. In another example embodiment, movement along a first axis determines the frequency of the tone produced and movement along a second axis determines the amplitude of the tone produced. It will be appreciated that various combinations of the exemplary functions described above would be possible to achieve with a multi-axial accelerometer.

The audio signal is routed to a sound output device, such as a speaker 228. The speaker 228 comprises a transducer that converts the electrical audio signal to sound. Rendering the audio signal audible to the user in this manner allows the user to understand how the movement of the handset causes changes in the audio signal. Thus, the user receives audible feedback on the correlation between the movement and the change in the frequency of the tones emitted by the speaker. By continually moving the wireless handset through space, the user generates a tune comprised of a series of tones. The user can hear the tune as it is composed by listening to the tones reproduced by the speaker.

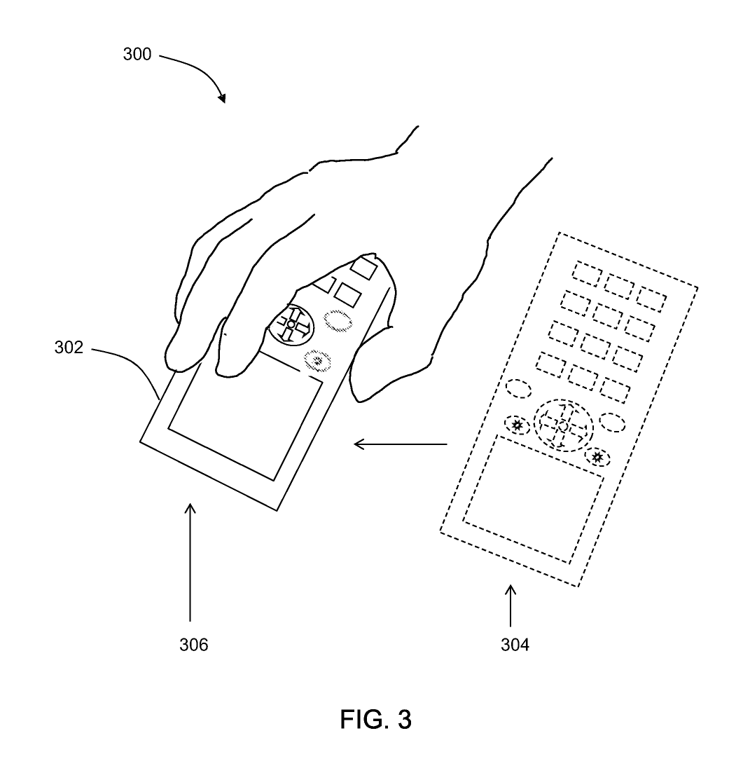

Referring to FIG. 3, there is shown the wireless handset 302 being used to compose a tune. The user whose hand is shown moves the device 302 through space from a first position 304 to a second position 306. The accelerometer in the device produces a signal indicating the acceleration of the device. The accelerometer may measure acceleration along a single axis, or a multi-axial accelerometer may allow measurement of acceleration along two or three axes. The processor converts one or more properties of the accelerometer signal to an audio signal. For example, the processor may produce an initial tone with an initial fundamental frequency at initial position 304 and then produce a second tone at a second position 306 with a second fundamental frequency that varies from the initial fundamental frequency in proportion to the distance the device is moved along a single axis.

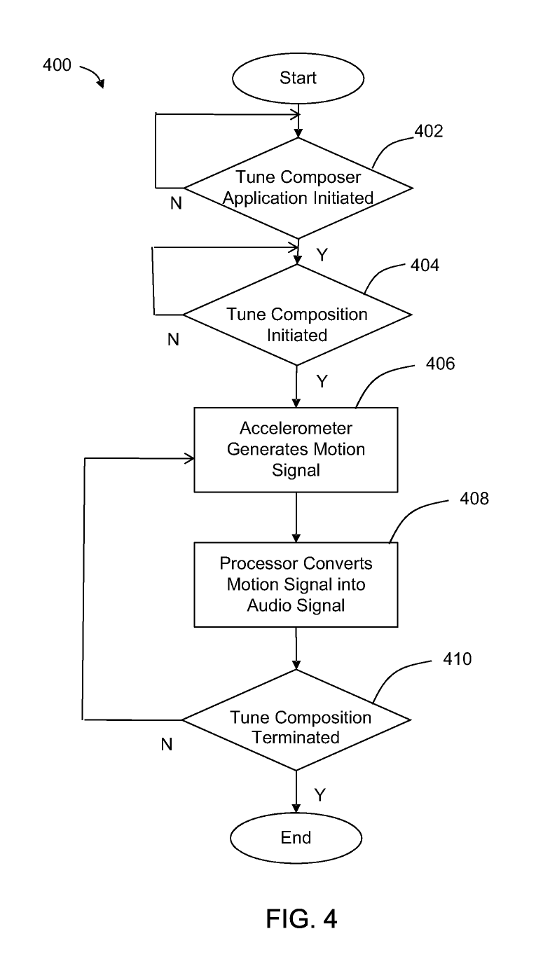

Referring to FIG. 4, there is shown an illustrative flowchart of an exemplary method for generating an audio signal in response to the motion of the wireless handset. At decision diamond 402, the wireless handset processor repeatedly determines whether the Tune Composer application has been initiated.

If the Tune Composer application has been initiated, the wireless handset processor then repeatedly determines whether tune composition has been initiated, as illustrated at decision diamond 404. Generally, the Tune Composer application will offer a range of functions, including a tune composition mode accessible from within the Tune Composer application. Alternatively, a tune composition mode may be initiated simultaneously with initiation of the Tune Composer Application.

If tune composition has been initiated, the processor gathers motion signal data from the accelerometer, as indicated at block 406. The processor converts the motion signal into an audio signal, as indicated at block 408. At decision diamond 410, a determination is made to continue gathering and converting motion signals until tune composition has been terminated.

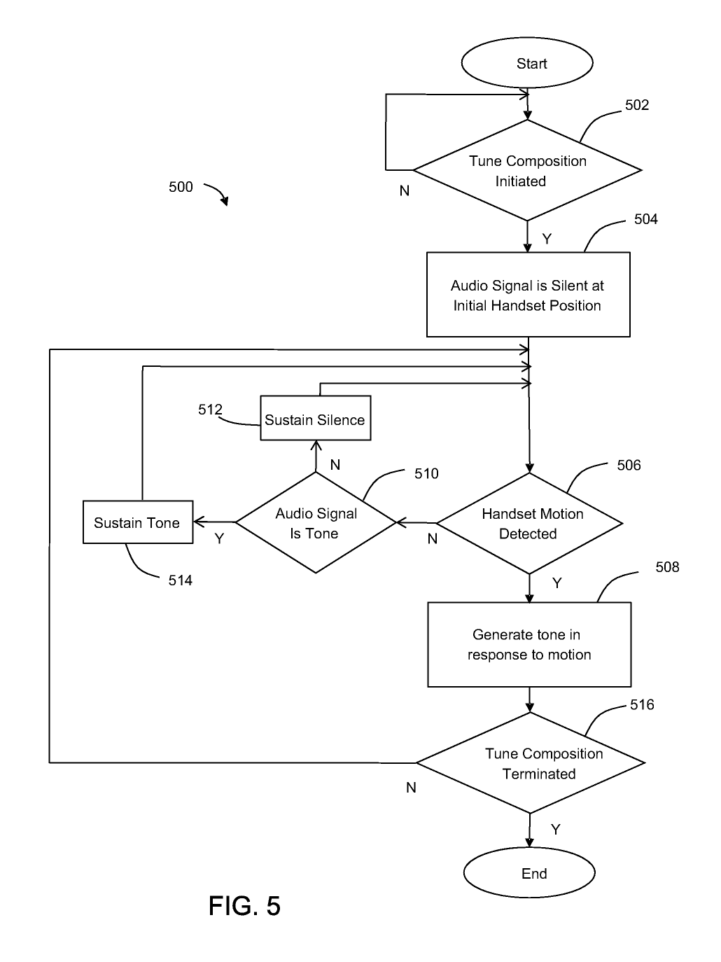

Referring to FIG. 5, an illustrative flowchart of the method for generating an audio signal responsive to wireless handset motion is shown. The wireless handset processor repeatedly determines whether tune composition has been initiated, as illustrated at decision diamond 502. If the Tune Composition Application has been initiated, the method proceeds to identify the wireless handset and the wireless handset speaker generates no tone (the handset is silent), as indicated at block 504.

At the decision diamond 506, the wireless handset processor repeatedly determines whether movement of the wireless handset has occurred. If motion has been detected, a tone is generated in response to the motion, as indicated at block 508. For example, the processor may generate an audio signal consisting of a tone with a frequency representative of the change of the position of the handset along a particular axis, as sensed by the accelerometer.

If no motion is detected at decision diamond 506, the audio signal is sustained in its current state. A determination of the audio signal state is performed at decision diamond 512. Therefore, if the handset has not been moved from its initial position at decision diamond 512, the method proceeds to generate no tone (the handset is silent) and the silence is sustained as indicated by block 512. If the handset has been moved from its initial position and is generating a tone, the frequency of the tone is sustained as represented by block 514.

In an alternative embodiment, a rest can be inserted in a tune by moving the handset back to its initial position. A rest is a period of silence between musical notes in a tune. The initial position is the position of the handset when the tune composition is initiated. Thus, when the handset is returned to its initial position, the audio signal is silent for the duration of the time that the handset remains at the initial position. When the handset is moved to a different position, a tone is generated.

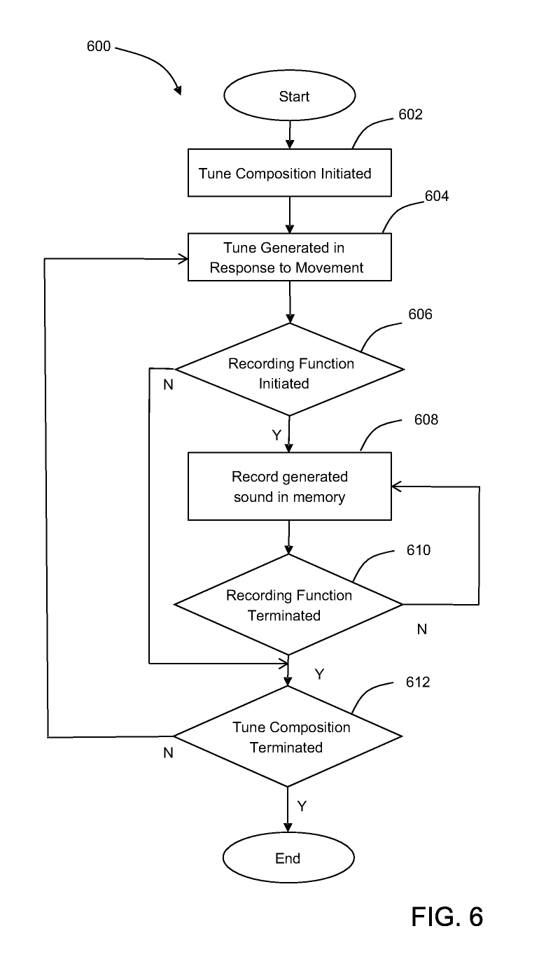

Referring to FIG. 6 there is shown an illustrative flowchart of a method for recording the audio signal generated in response to wireless handset motion. Tune composition is initiated in block 602, resulting in a tune generated in response to the movement of the wireless handset as indicated at block 604 and described above.

If a recording function is initiated at decision diamond 606, the sound generated during tune composition is recorded in memory as indicated by block 608. Recording continues until the recording function is terminated, as indicated at decision diamond 610. Tune generation continues until tune composition is terminated, as indicated at decision diamond 612. In some embodiments, recording is terminated automatically when the tune composition is terminated. Recording may likewise be initiated automatically when tune composition is initiated.

The recorded tune may be saved to memory as an .mp3 file, a .wav file, a .midi file, or another audio storage format. When a tune has been recorded, the Tune Composer Application may provide tools for assigning the recorded tune to a ringtone.

The Tune Composer application enables the user to grasp the wireless handset in one hand and wave the handset through the air. As the handset is moved through space, the accelerometer senses the acceleration of the handset. The processor derives the change in the position of the handset from the accelerometer signal. The processor converts the position data into an audio signal, such that the characteristics of the audio signal change in correlation to the position data collected by the accelerometer. For example, as the position of the phone changes along a particular axis, tones are produced with frequencies that vary in proportion to the change in position.

An application for converting the motion of a wireless handset into an audio signal has been described above. A processor associated with the wireless handset converts the motion signal generated by an accelerometer associated with the wireless handset into an audio signal, which is emitted by a speaker associated with the wireless handset. The tune produced may be recorded. In certain instances, the Tune Composer application will play a previously recorded tune in a repeated loop as one track while simultaneously generating sound correlated to the movement of the wireless handset as a second track. In this manner, multiple track recordings can be performed using the Tune Composer Application.

It is to be understood that the detailed description of illustrative embodiments are provided for illustrative purposes. The scope of the claims is not limited to these specific embodiments or examples. Therefore, various process limitations, elements, details, and uses can differ from those just described, or be expanded on or implemented using technologies not yet commercially viable, and yet still be within the inventive concepts of the present disclosure. The scope of the invention is determined by the following claims and their legal equivalents.

What is claimed is:

1. A wireless handset, comprising:
a processor;
an accelerometer operatively coupled to the processor, wherein the accelerometer produces an accelerometer signal corresponding to acceleration of the wireless handset;
an audio signal generated by the processor, wherein the processor converts the accelerometer signal to the audio signal; and
a speaker operatively coupled to the processor, wherein the speaker comprises a transducer that receives the audio signal and generates a speaker output, the speaker output indicating the response of the audio signal to the acceleration of the wireless handset.

2. The wireless handset of claim 1, further comprising a memory module operatively coupled to the processor, wherein the audio signal is stored to the memory module.

3. The wireless handset of claim 2, wherein the audio signal stored in memory is assignable to a ringtone.

4. The wireless handset of claim 2, further comprising a display operatively coupled to the processor, wherein the display shows a visual depiction of the audio signal stored in memory.

5. The wireless handset of claim 1, further comprising a display operatively coupled to the processor, wherein the display shows a visual depiction of the audio signal as the audio signal is produced.

6. The wireless handset of claim 1,
wherein the processor increases the frequency of the audio signal when the wireless handset is displaced in a first direction along a first axis;
wherein the processor decreases the frequency of the audio signal when the wireless handset is displaced in a second direction that is the reverse of the first direction along the first axis;
wherein the processor sustains the frequency of the audio signal over a period of time during which a position of the wireless handset is unaltered.

7. A wireless handset, comprising:
a processor;
a motion sensing means operatively coupled to the processor, wherein the motion sensing means produces a motion signal corresponding to a change in position of the wireless handset;
an audio signal generated by the processor, wherein the processor converts the motion signal to the audio signal; and
a sound output device operatively coupled to the processor, wherein the sound output device comprises a transducer that receives the audio signal and generates a sound output, the sound output indicating the response of the audio signal to the motion of the wireless handset.

8. The wireless handset of claim 7, further comprising a memory module operatively coupled to the processor, wherein the audio signal is stored to the memory module.

9. The wireless handset of claim 8, wherein the audio signal stored in memory is assignable to a ringtone.

10. The wireless handset of claim 8, further comprising a display operatively coupled to the processor, wherein the display shows a visual depiction of the audio signal stored in memory.

11. The wireless handset of claim 7, further comprising a display operatively coupled to the processor, wherein the display shows a visual depiction of the audio signal as the audio signal is produced.

12. The wireless handset of claim 7,
wherein the processor increases the frequency of audio signal when the wireless handset is displaced in a first direction along a first axis;
wherein the processor decreases the frequency of the audio signal when the wireless handset is displaced in a second direction that is the reverse of the first direction along the first axis;
wherein the processor sustains the frequency of audio signal over a period of time during which a position of the wireless handset is unaltered.

13. A method for producing an audio signal with a wireless handset, the method comprising:
moving the handset;
sensing the motion of the handset with an accelerometer;
converting the motion signal to an audio signal;
receiving the audio signal with a transducer;
generating a speaker output with the transducer, the speaker output indicating the response of the audio signal to the acceleration of the wireless handset.

14. The method of claim 13, further comprising storing the audio signal to memory.

15. The method of claim 14, further comprising assigning the audio signal stored in memory to a ringtone.

16. The method of claim 14, further comprising showing a visual representation of the audio signal stored in memory on a display.

17. The method of claim 13, further comprising showing a visual representation of the audio signal on a display, wherein the visual representation of the sound signal is updated in real time.

18. The method of claim 13, further comprising varying the frequency characteristics of the audio signal in relation to the movement of the wireless handset along one or more axes.
